(19) United States
(12) Patent Application Publication
(10) Pub. No.: US 2006/0008178 A1
(43) Pub. Date: Jan. 12, 2006

(54) Simulation of scanning beam images by combination of primitive features extracted from a surface model

(76) Inventors: Adam A. Seeger, Sunnyvale, CA (US); Horst W. Haussecker, Palo Alto, CA (US)

Correspondence Address: TROP PRUNER & HU, PC, 8554 KATY FREEWAY, SUITE 100, HOUSTON, TX, 77024, US

(21) Appl. No.: 10/886,910

(22) Filed: Jul. 8, 2004

(51) Int. Cl. G06K 9/36; G09G 5/00

(52) U.S. Cl. 382/284; 345/632

(57) ABSTRACT

A technique includes filtering a sampled representation of an object that might be observed in a scanning beam image with a plurality of filters to produce a plurality of intermediate images. The intermediate images are combined to generate a simulated image that predicts what would be observed in the scanning beam.

### BACKGROUND

The invention generally relates to the simulation of scanning beam images by combination of primitive features, such as primitive features that are extracted from a surface model, for example.

A scanning beam imaging tool, such as a scanning electron microscope (SEM), focused ion beam (FIB) tool, or optical scanner, typically is used for purposes of generating an image of a micro-scale or nano-scale surface. As examples, the surface may be the surface of a silicon semiconductor structure or the surface of a lithography mask that is used to form a layer of the semiconductor structure.

The scanning beam imaging tool may provide a two-dimensional (2-D) image of the surface. Although the 2-D image from the tool contains intensities that identify surface features, it is difficult for a human to infer the three-dimensional (3-D) structure of the surface from an image. To aid interpreting the 2-D image, the surface may be physically cut and the tool may be used to generate additional 2-D images showing cross sections of this surface.

Simulated images may also be used to interpret the 2-D image from the scanning beam imaging tool. The image acquired by a scanning beam image tool can be simulated by a computer-aided simulation that models the physical interaction between the scanning beam of the tool and a hypothetical surface. One such simulation is called a Monte Carlo simulation, which is a standard approach for simulating the physics behind the image that is generated by the tool. The Monte Carlo model is based on a physical simulation of electron or ion scattering. Because the scattering simulation is randomized and many particles must be simulated in order to produce the simulated image with relatively low noise, the Monte Carlo simulation may take a significant amount of time to be performed. Also, the Monte Carlo simulation does not express the simulation output in terms of an analytic function that can be used for subsequent processing steps. Another approach to simulation uses what is called a shading model, in which the intensity in scanning beam image is modeled as a function of the local surface orientation. This method is not accurate at the nanometer scale but does express the simulation in terms of an analytic function.

Thus, there is a continuing need for faster and more accurate ways to simulate an image from a scanning beam image tool. Also, there is a need to be able to express the relationship between surface shape at the nanometer scale and scanning beam image intensity using an analytic function.

### BRIEF DESCRIPTION OF THE DRAWING

FIG. 1 is a block diagram illustrating a technique to simulate a scanning beam tool image according to an embodiment of the invention.

FIG. 2 is a flow diagram depicting a technique to train a filter bank of FIG. 1 according to an embodiment of the invention.

FIG. 3 is a block diagram depicting training and simulation techniques to derive a simulated image according to an embodiment of the invention.

FIG. 4 is a schematic diagram of a computer system according to an embodiment of the invention.

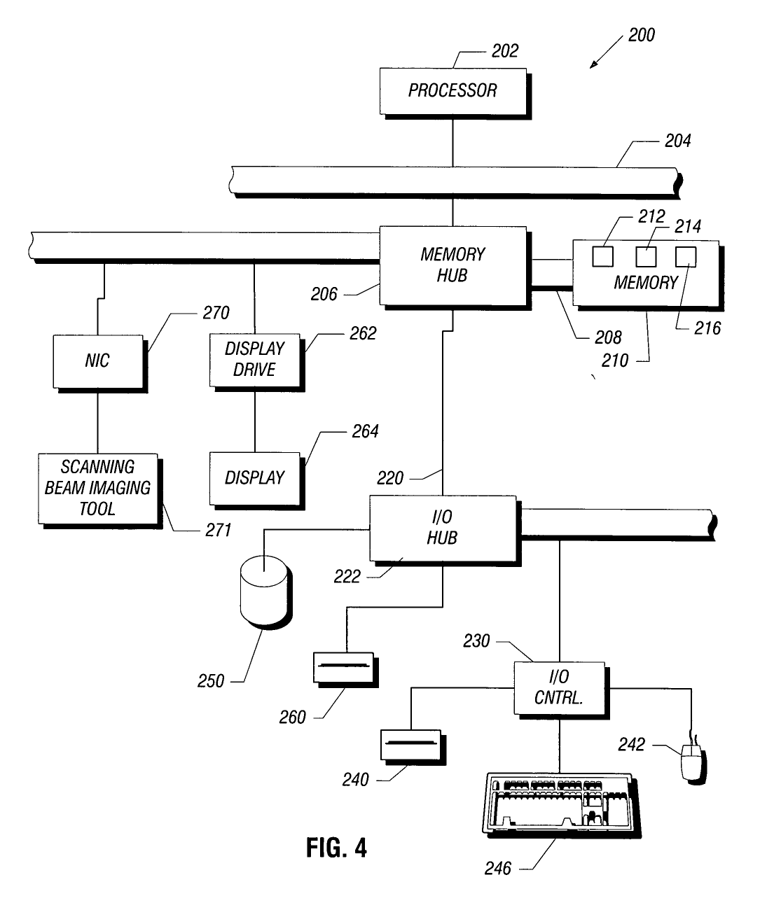

### DETAILED DESCRIPTION

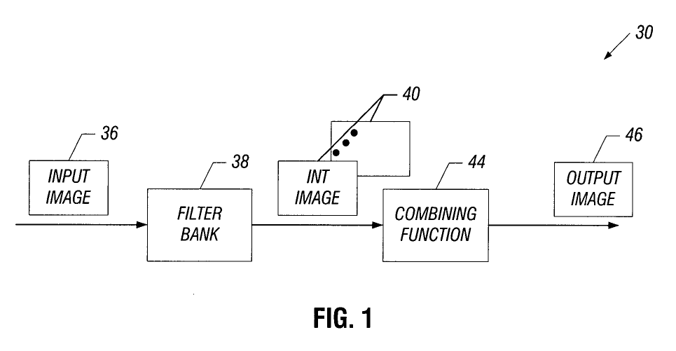

Referring to FIG. 1, an embodiment of a system 30 in accordance with the invention simulates an image of a surface, which could be generated by a scanning beam tool (a scanning electron microscope (SEM) or a focused ion beam (FIB) tool, as examples). The surface is “microscopic surface,” which means the simulation technique is capable of modeling beam interactions with features on the surface less than 100 microns (and in some embodiments of the invention, less than 10 nanometers in size). As examples, the surface may be the surface of a lithography mask or the surface of a semiconductor structure.

The system 30 receives an input image 36 (further described below) that indicates characteristics of the surface, and based on the input image 36, the system 30 generates an output image 46, a simulated scanning beam image of the surface. The output image 36 may be used for numerous purposes, such as interpreting an actual 2-D image of the surface obtained from a scanning beam imaging tool, for example.

In some embodiments of the invention, the input image 36 is a height field image, which means the intensity of each pixel of the image 36 indicates the height of an associated microscopic feature of the surface. Thus, for example, a z-axis may be defined as extending along the general surface normal of the surface, and the intensity of each pixel identifies the z coordinate (i.e., the height) of the surface at a particular position of the surface. Even if the specimen under measurement has undercuts or voids, some undercutting may be handled by this approach if the structure of the undercut is predictable from the first surface height. For example, if the shape of an undercut is a function of the height of a step edge, then the approach described herein may be used to model the intensity resulting from the beam interaction with the undercut surface.

The height image may be generated from manufacturing design specifications used to form the various semiconductor layers and thus, form the observed surface. Other variations are possible, in other embodiments of the invention.

The system 30 includes a filter bank 38 that receives the input image 36. The filter bank 38 contains N filters, each of which produces a corresponding intermediate image 40. The filters of the filter bank 38 are designed to identify particular local features that might appear on the observed surface. A combining function 44 combines the intermediate images 40 to produce the final output image 46.

As described further below, in some embodiments of the invention, each filter of the filter bank 38 may be derived from a local polynomial approximation to the input image. The polynomial approximation, in turn, provides an approximation to one of three local features at the pixel (in some embodiments of the invention): the minimum and maximum principal curvatures for the surface at the pixel and surface slope at the pixel.

Each filter defines a particular area around the pixel, accounting for different feature sizes on the surface. For example, a particular filter may form the associated intermediate image 40 by fitting a polynomial function to the pixel intensities over an appropriate 3 pixel-by-3 pixel area around the pixel and computing an output value from the coefficients of the polynomial. Other filters may be associated with different scales such as 10 pixel-by-10-pixel areas, 30 pixel-by-30 pixel areas, etc. Thus, each of the three basic features (slope, minimum curvature and maximum curvature) described above may be associated with different scales. For example, ten filters may approximate the local slopes surrounding each pixel for ten different pixel scales; ten more filters may approximate the minimum principal curvature surrounding each pixel for ten different pixel scales; and ten additional filters may approximate the maximum principal curvature surrounding each pixel for ten different pixel scales. The numbers stated herein are by way of example only, as the number of filters of the filter bank 38 varies according to the particular embodiment of the invention.

In some embodiments of the invention, the technique described herein includes an algorithm to fit an image formation model to example pairs of actual surfaces and the corresponding scanning tool images. Furthermore, as described below, the technique includes computing the derivative of a simulated image with respect to a parameter controlling the surface shape. A primary feature of the technique is to represent simulated images as functions of a set of local geometric image features in the input surfaces.

The technique described herein uses a training algorithm that learns the relationship between the geometric properties of the surface and the image intensity. The local features are computed on multiple scales that are motivated by different scales of the physical interaction of the scanning beam and the specimen. The learning algorithm also determines the appropriate set of local features and spatial scales to reduce the dimensionality without loss of accuracy. After the system is trained, any input surface may be simulated by decomposing it into the learned set of local geometric features and combining these into the learned image generation function.

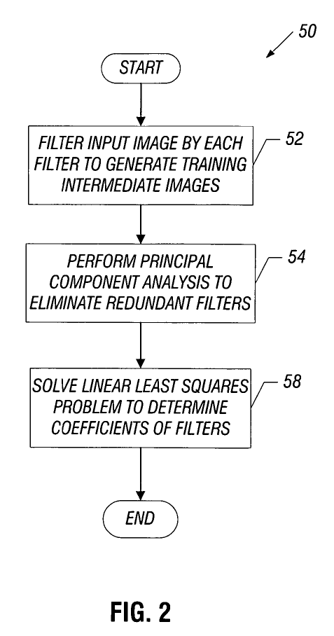

As a more specific example, FIG. 2 depicts a technique 50 to derive the coeffients for the filters of the filter bank 38. The technique 50 includes filtering (block 52) the input image 36 by each filter of the filter bank 38 to generate training the intermediate images 40. Next, a principal component analysis is performed (block 54) to eliminate redundant filters, i.e., filters that produce essentially the same intermediate image 40 for a given input image 36. Lastly, according to the technique 50, a linear least squares problem is solved (block 58) to determine the coeffients of the filters of the filter bank 38.

Turning now to the more specific details, in some embodiments of the invention, the combining function may be described as follows:

$$I ( H , x ) = d + {\sum }_{i = 1 … N} {a}_{i} {F}_{i} ( H , x ) , \qquad Equation 1$$

where “H” represents the height field image; “x” represents a particular pixel location; “i” is an index for the filter, ranging from 1 to N; “Fᵢ” represents the ith filter of the filter bank; “aᵢ” represents the multiplication factor coefficient for the ith filter; and “d” represents a constant offset. This is only one possibility. Non-linear combining functions are possible. Also, the training procedure we describe is applicable to any combining function that is a polynomial function of the filter bank outputs.

The aᵢ coefficients are derived using a training procedure to determine which filters are important for computing the final output image 46. For example, for simplicity, assume an input image 36 called “Hₜᵣₐᵢₙ” and a resulting output image 46 called “Iₜᵣₐᵢₙ.” During training, the Hₜᵣₐᵢₙ image is filtered by each of the filters of the filter bank 38 to generate a set of intermediate training images. Next, a principal component analysis of the output images is performed to eliminate redundant dimensions in the filter basis.

In some embodiments of the invention, the principal components are computed as the eigenvectors of an N×N correlation matrix of the intermediate training images. The eigenvalues of the correlation matrix measure the amount of variation in the intermediate training images. In some embodiments of the invention, principal components whose eigenvalues are less than 1.0 may be ignored. In other embodiments of the invention, the principal components are not ignored unless the eigenvalues are less than 0.1. Other thresholds may be used, in other embodiments of the invention.

After determining the principal components, the following linear least squares problem, described below, is solved:

$${I}_{train} ( X ) = d + {\sum }_{i = 1 … M} {b}_{i} {\sum }_{j = 1 … N} {PC}_{i} [ j ] \cdot {F}_{j} ( {H}_{train} ) , \qquad Equation 2$$

where “PCᵢ[j]” represents the jth element of the ith principal component (i indexes the principal components in order from largest to smallest eigenvalue); “M” represents the number of principal components with eigenvalues greater than 0.1 (M≦N); d represents a constant offset; and the “bᵢ” represents coefficients of the principal component filter output images that are computed by the inner summation.

Finally, the a s components are derived as follows:

$${a}_{i} = {\sum }_{j = 1 … M} {PC}_{j} [ i ] \cdot {b}_{j} , \qquad Equation 3$$

If one of the intermediate training images has a relatively small contribution to the total output, then the corresponding filter may be removed from the filter bank 38, and the fitting process is repeated to make a more efficient model, in some embodiments of the invention. Once the parameters have been determined from the above-described training technique, the filter bank 38 may be used to synthesize images from novel input images 36 provided by sampling the height from any hypothetical 3-D model of the surface.

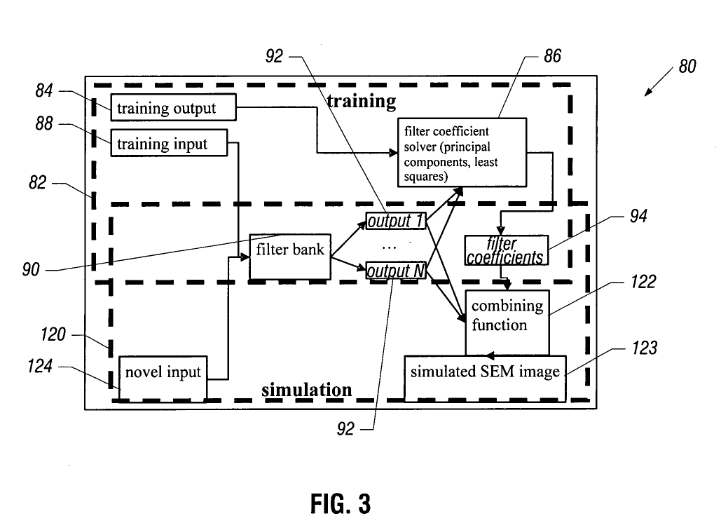

Referring to FIG. 3, thus, a technique 80 in accordance with the invention overlaps a training technique 82 to derive the filter coefficients with a simulation technique 120 that uses the filter coefficients to produce the output image 36. Regarding the training technique 82, a training input image 88 is provided to a filter bank 90. The filter bank 90, in turn, produces N outputs 92. A filter coefficient solver 86 (i.e., a solver that calculates the principal components and the least squares, as described above) uses the outputs 92 to derive filter coefficients 94. The filter bank 90 and filter coefficients 94 provide overlap between the training technique 82 and the simulation technique 120. In this manner, for the simulation technique 120, the filter bank 90 receives a novel input image 124 from the scanning beam tool 32, computes the outputs 82 and provides these outputs to a combining function 122 that, in turn, produces a simulated image 123.

In some embodiments of the invention, the filter bank that is used is based on computing the height gradient magnitude and principal curvatures from local cubic approximations to the input surface. However, the proposed algorithm is not limited to these filters. Any other set of filters can be used to compute local geometric features if they are appropriate to represent the relationship between local surface structure and image intensity. Using nonlinear features enables representation of a highly nonlinear phenomenological relationship. The output of the individual filters in the filter bank corresponds to the gradient magnitude and curvature values at each pixel of the input height image. In some embodiments of the invention, filter kernels that compute the local cubic approximations with a Gaussian weighted fit are used. Using a Gaussian weighted fit helps to reduce undesirable ringing effects near sharp edges.

In some embodiments of the invention, a facet model is used to estimate slope and curvature. A facet model represents an image as a polynomial fit to the intensities in the local neighborhood of each pixel. The image is thus represented as a piecewise polynomial function with a different polynomial for each pixel (one facet per pixel). For the cubic facet model a local neighborhood of an image, f(r, c), is approximated by a two-dimensional cubic polynomial, as described below:
f(r,c)≈K₁+K₂r+K₃c+K₄r²+K₅rc+K₆c²+K₇r³+K₈r²c+K₉rc²+K₁₀c³, Equation 4
where r ε R and c ε C represent row and column indices for a rectangular-shaped neighborhood with center at (0,0), and all ten K coefficients are constants that are specific to a neighborhood centered about a particular pixel. For example, for a 5×5 neighborhood, R=C={−2, 1, 0, 1, 2}.

Given a cubic facet model, the slope (gradient magnitude) and curvature (two principal curvatures) for each pixel are computed as described below:

$$\begin{matrix}G = \sqrt{{K}_{2}^{2} + {K}_{3}^{2}} , & Equation 5 \\ {κ}_{+} = \frac{1}{2} ( {K}_{6} + {K}_{4} + \sqrt{{K}_{6}^{2} + {K}_{4}^{2} - 2 {K}_{6} {K}_{4} + 4 {K}_{5}^{2}} ) , & Equation 6 \\ {κ}_{-} = \frac{1}{2} ( {K}_{6} + {K}_{4} - \sqrt{{K}_{6}^{2} + {K}_{4}^{2} - 2 {K}_{6} {K}_{4} + 4 {K}_{5}^{2}} ) , & Equation 7\end{matrix}$$

where “G” is the gradient magnitude and K₊ and K are the principal curvatures. These three operators for a variety of neighborhood sizes are then used as the filter basis. The circular symmetry of these filters is appropriate because the Monte Carlo model assumes circular symmetry in the detector geometry. As can be seen from these formulae, only K₂, K₃, K₄, K₅ and K₆ are needed. Fortunately, the polynomial coefficients can each be efficiently computed using a convolution operation, described below.

Alternatively, the coefficients for higher order polynomial fits may be used. Also, Gabor filters may be useful for capturing the effects of periodic structures on intensity. In SEM images, repeated structures in close proximity typically have different contrast from the same structures in isolation. In the case of an SEM where the detector geometry is not circularly symmetric, the coefficients of the cubic polynomial may be used separately as the filters instead of combining them into gradient magnitude and principal curvatures.

In some embodiments of the invention, a Gaussian weighting function is used. The support neighborhood size is still an odd integer but an additional width parameter for the Gaussian function provides continuous control over the effective neighborhood size. The Gaussian weighting function has the advantage of preserving separability and is defined as follows:
w(r, c)=wᵣ(|r|)·w_{c}(|c|)=k·e^{-(r}^{²}^{+c}^{²}^{)/(2σ}^{²}⁾ Equation 8
where wᵣ(x)=w_{c}(x)=\sqrt{k} exp(−x²/(2σ²)) and k is a normalizing factor such that Σ_{c}Σ_{c}w(r, c)=1.

To fit a polynomial using a weighting function the weighted squared error is minimized as described below

$${e}^{2} = {\sum }_{r ε R} {\sum }_{c ε C} w ( r , c ) \cdot {( \begin{matrix}{K}_{1} + {K}_{2} r + {K}_{3} c + {K}_{4} {r}^{2} + {K}_{5} rc + {K}_{6} {c}^{2} + \\ {K}_{7} {r}^{3} + {K}_{8} {r}^{2} c + {K}_{9} {rc}^{2} + {K}_{10} {c}^{3} - f ( r , c )\end{matrix} )}^{2} , \qquad Equation 9$$

The convolution kernels for the coefficients of the Gaussian-weighted facet model are described in the appendix.

In some embodiments of the invention, the convolution kernels are computed which when convolved with an image give the facet model representation of that image minimizing the following equation, a general solution for the K coefficients may be described as follows:

$$\begin{matrix}{e}^{2} = {\sum }_{r ε R} {\sum }_{c ε C} {( {K}_{1} + {K}_{2} r + {K}_{3} c + {K}_{4} {r}^{2} + {K}_{5} rc + {K}_{6} {r}^{2} + {K}_{7} {r}^{3} + {K}_{8} {r}^{2} c + {K}_{9} {rc}^{2} + {K}_{10} {c}^{3} - f ( r , c ) )}^{2} , & Equation 10 \\ {R}_{n} = {\sum }_{r ε R} {r}^{2 n} and {C}_{n} = {\sum }_{c ε C} {C}^{2 n} for n = 0 , 1 , 2 , 3 , & Equation 11 \\ G = {R}_{0} {R}_{2} {C}_{0} {C}_{2} - {R}_{1}^{2} {C}_{1}^{2} , & Equation 12 \\ A = {R}_{1} {R}_{3} {C}_{0} {C}_{2} - {R}_{2}^{2} {C}_{1}^{2} , & Equation 13 \\ B = {R}_{0} {R}_{2} {C}_{1} {C}_{3} - {R}_{1}^{2} {C}_{2}^{2} , & Equation 14 \\ Q = {C}_{0} ( {R}_{0} {R}_{2} - {R}_{1}^{2} ) , & Equation 15 \\ T = {R}_{0} ( {C}_{0} {C}_{2} - {C}_{1}^{2} ) , & Equation 16 \\ U = {C}_{0} ( {R}_{1} {R}_{3} - {R}_{2}^{2} ) , & Equation 17 \\ V = {C}_{1} ( {R}_{0} {R}_{2} - {R}_{1}^{2} ) , & Equation 18 \\ W = {R}_{1} ( {C}_{0} {C}_{2} - {C}_{1}^{2} ) , & Equation 19 \\ Z = {R}_{0} ( {C}_{1} {C}_{3} - {C}_{2}^{2} ) , & Equation 20\end{matrix}$$

In terms of these definitions, the solution is as follows:

$$\begin{matrix}{K}_{1} = \frac{1}{QT} {\sum }_{r} {\sum }_{c} ( G - {TR}_{1} {r}^{2} - {QC}_{1} {c}^{2} ) f ( r , c ) , & Equation 21 \\ {K}_{2} = \frac{1}{UW} {\sum }_{r} {\sum }_{c} ( A - {WR}_{2} {r}^{2} - {UC}_{1} {c}^{2} ) rf ( r , c ) , & Equation 22 \\ {K}_{3} = \frac{1}{VZ} {\sum }_{r} {\sum }_{c} ( B - {ZR}_{1} {r}^{2} - {VC}_{2} {c}^{2} ) cf ( r , c ) , & Equation 23 \\ {K}_{4} = \frac{1}{Q} {\sum }_{r} {\sum }_{c} ( {R}_{0} {r}^{2} - {R}_{1} ) f ( r , c ) , & Equation 24 \\ {K}_{5} = \frac{{\sum }_{r} {\sum }_{c} rcf ( r , c )}{{\sum }_{r} {\sum }_{c} {r}^{2} {c}^{2}} , & Equation 25 \\ {K}_{6} = \frac{1}{T} {\sum }_{r} {\sum }_{c} ( {C}_{0} {c}^{2} - {C}_{1} ) f ( r , c ) , & Equation 26 \\ {K}_{7} = \frac{1}{U} {\sum }_{r} {\sum }_{c} ( {R}_{1} {r}^{2} - {R}_{2} ) rf ( r , c ) , & Equation 27 \\ {K}_{8} = \frac{1}{V} {\sum }_{r} {\sum }_{c} ( {R}_{0} {r}^{2} - {R}_{1} ) cf ( r , c ) , & Equation 28 \\ {K}_{9} = \frac{1}{W} {\sum }_{r} {\sum }_{c} ( {C}_{0} {c}^{2} - {C}_{1} ) rf ( r , c ) , & Equation 29 \\ {K}_{10} = \frac{1}{Z} {\sum }_{r} {\sum }_{c} ( {C}_{1} {c}^{2} - {C}_{2} ) cf ( r , c ) , & Equation 30\end{matrix}$$

Each of the K coefficients corresponds to a 2-D image where each pixel represents the fit to a neighborhood centered on the corresponding pixel in an input image. The image for a K coefficient can be efficiently computed by a convolution with a convolution kernel the size of the neighborhood.

For computing the K coefficients using the Gaussian-weighted facet model, the variables G, A, B, Q, T, U, V, W, and Z from Equations 12-20 are computed by the same formulae except using variables Rₙ and Cₙ defined as follows:

$${R}_{n} = {\sum }_{r ε R} {w}_{r} ( r ) \cdot {r}^{2 n} and {C}_{n} = {\sum }_{c ε C} {w}_{c} ( c ) \cdot {c}^{2 n} for n = 0 , 1 , 2 , 3 , \qquad Equation 31$$

Then the coefficients are computed as follows:

$$\begin{matrix}{K}_{1} = \frac{1}{QT} {\sum }_{r} {\sum }_{c} w ( r , c ) ( G - {TR}_{1} {r}^{2} - {QC}_{1} {c}^{2} ) f ( r , c ) & Equation 32 \\ {K}_{2} = \frac{1}{UW} {\sum }_{r} {\sum }_{c} w ( r , c ) ( A - {WR}_{2} {r}^{2} - {UC}_{1} {c}^{2} ) rf ( r , c ) , & Equation 33 \\ {K}_{3} = \frac{1}{VZ} {\sum }_{r} {\sum }_{c} w ( r , c ) ( B - {ZR}_{1} {r}^{2} - {VC}_{2} {c}^{2} ) cf ( r , c ) , & Equation 34 \\ {K}_{4} = \frac{1}{Q} {\sum }_{r} {\sum }_{c} w ( r , c ) ( {R}_{0} {r}^{2} - {R}_{1} ) f ( r , c ) , & Equation 35 \\ {K}_{5} = \frac{{\sum }_{r} {\sum }_{c} w ( r , c ) rcf ( r , c )}{{\sum }_{r} {\sum }_{c} w ( r , c ) {r}^{2} {c}^{2}} , & Equation 36 \\ {K}_{6} = \frac{1}{T} {\sum }_{r} {\sum }_{c} w ( r , c ) ( {C}_{0} {c}^{2} - {C}_{1} ) f ( r , c ) , & Equation 37 \\ {K}_{7} = \frac{1}{U} {\sum }_{r} {\sum }_{c} w ( r , c ) ( {R}_{1} {r}^{2} - {R}_{2} ) rf ( r , c ) , & Equation 38 \\ {K}_{8} = \frac{1}{V} {\sum }_{r} {\sum }_{c} w ( r , c ) ( {R}_{0} {r}^{2} - {R}_{1} ) cf ( r , c ) , & Equation 39 \\ {K}_{9} = \frac{1}{W} {\sum }_{r} {\sum }_{c} w ( r , c ) ( {C}_{0} {c}^{2} - {C}_{1} ) rf ( r , c ) , & Equation 40 \\ {K}_{10} = \frac{1}{Z} {\sum }_{r} {\sum }_{c} w ( r , c ) ( {C}_{1} {c}^{2} - {C}_{2} ) cf ( r , c ) , & Equation 41\end{matrix}$$

Referring to FIG. 5, in accordance with an embodiment of the invention, the above-described techniques may be used in connection with a computer system 200. More specifically, the computer system 200 may include a memory 210 that stores instructions 212 that cause a processor 202 to perform the simulation and training techniques described above. Additionally, the memory 210 may also store data 214 that represents an input image 36, such as a height field image, for example. Furthermore, the memory 210 may store data 216 that represents the results of the simulation technique, i.e., the output image 46.

Among the other features of the computer system 200, the computer system 200 may include a memory bus 208 that couples the memory 210 to a memory hub 206. The memory hub 206 is coupled to a local bus 204, along with a processor 202. The memory hub 206 may be coupled to a network interface card (NIC) 270 and a display driver 262 (that drives a display 264) for example. Furthermore, the memory hub 206 may be linked (via a hub link 220) to an input/output (I/O) hub 222, for example. The I/O hub 222, in turn, may provide interfaces for a CD ROM drive 260 and/or a hard disk drive 250, depending on the particular embodiment of the invention. Furthermore, an I/O controller 230 may be coupled to the I/O hub 222 for purposes of providing the interfaces for a keyboard 246, mouse 242 and floppy disk drive 240.

Although FIG. 5 depicts the program instructions 212, input image data 214 and output image data 216 as being stored in the memory 210, it is understood that one or more of these instructions and/or data may be stored in another memory, such as in the hard disk drive 250 or in a removable media, such as a CD ROM that is inserted into the CD-ROM drive 260. In some embodiments of the invention, the system 200 indicates a scanning beam imaging tool 271 (a scanning electron microscope (SEM) or focused ion beam (FIB) tool, as examples) that is coupled to the system 200 via the NIC 270. The tool 271 provides data indicating a scanned image (a 2-D image, for example) of a surface under observation. The system 200 may display the scanned image as well as a simulated image produced by the techniques described herein, on the display 264. Thus, many embodiments of the invention are contemplated, the scope of which are defined by the appended claims.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A method comprising:
filtering a sampled representation of an object that might be observed in a scanning beam image with a plurality of filters to produce a plurality of intermediate images; and
combining the intermediate images to generate a simulated image that predicts what would be observed in the scanning beam image.

2. The method of claim 1, wherein the sampled object representation comprises a height field image derived from a manufacturing specification.

3. The method of claim 1, wherein the filtering comprises:
associating the filters with different geometric features.

4. The method of claim 3, wherein the features comprise at least one a slope, a minimum curvature and a maximum curvature.

5. The method of claim 1, wherein the representation comprises pixels and the filtering comprises:
for each filter, applying a function to each pixel of the representation and to surrounding pixels defined with a region surrounding said each pixel.

6. The method of claim 5, further comprising:
varying the sizes of the regions for different filters.

7. The method of claim 1, wherein the representation and a corresponding output image comprise a training input/output set, the method further comprising:
using the training set to determine coefficients of the filters.

8. The method of claim 1, wherein the representation considered as a training input, the method further comprising:
using the training input to eliminate at least one of the filters.

9. The method of claim 7, wherein using the training input comprises:
determining a correlation matrix of the intermediate images; and
determining eigenvalues of the correlation matrix.

10. An article comprising a computer readable storage medium storing instructions to cause a processor-based system to:
filter a sampled representation of an object with a plurality of filters to produce a plurality of intermediate images; and
combine the intermediate images to generate a simulated image of the object.

11. The article of claim 10, wherein the representation comprises a height field image derived from a manufacturing specification.

12. The article of claim 10, the storage medium storing instructions to cause the processor-based system to associate the filters with different geometric features.

13. The article of claim 10, wherein the representation and a desired corresponding output image comprise a training input/output set and the storage medium storing instructions causes the processor-based system to use the desired output image to determine coefficients of the filters.

14. The article of claim 10, wherein the representation comprises a training input, and the storage medium storing instructions causes the processor-based system to use the training input to eliminate at least one of the filters.

15. The article of claim 10, the storage medium storing instructions to cause the processor to determine a correlation matrix of the intermediate images, determine eigenvalues of the correlation matrix and use the results of the determination to eliminate at least one of the filters.

16. A system comprising:
a processor;
a memory storing instructions to cause a processor to:
filter a sampled representation of an object with a plurality of filters to produce a plurality of intermediate images; and
combine the intermediate images to generate a simulated image of the object.

17. The system of claim 16, wherein the representation comprises a height field image derived from a manufacturing specification.

18. The system of claim 16, the memory storing instructions to cause the processor to simulate a scanning beam imaging tool from a synthetic object representation to generate the desired output image composing the training input/output set used to determine the coefficients of the filters.

19. The system of claim 16, wherein the processor associates the filters with different geometric features.

20. The system of claim 16, wherein the representation comprises a training input, wherein the processor uses a desired corresponding output image to determine coefficients of the filters.

21. The system of claim 16, wherein the representation comprises a training input, wherein the processor uses the training input to eliminate at least one of the filters.

22. A system comprising:
a scanning beam imaging tool;
a processor;
a memory storing instructions to cause a processor to:
filter a sampled representation of an object with a plurality of filters to produce a plurality of intermediate images; and
combine the intermediate images to generate a simulated image of the object,
wherein the simulated image is used to interpret another image generated by the scanning beam imaging tool.

23. The system of claim 22, wherein the representation comprises a height field image derived from a manufacturing specification.
